(19) United States
(12) Patent Application Publication
(10) Pub. No.: US 2026/0176162 A1
(43) Pub. Date: Jun. 25, 2026

(54) WATER FAUCET AND WATER PURIFICATION EQUIPMENT WITH MINERALIZATION

(71) Applicant: Guangdong Lizi Technology Co., Ltd., Foshan (CN)

(72) Inventors: Erqiang Duan, Foshan (CN); Guoxiang Chen, Foshan (CN); Xing Zhan, Foshan (CN); Yutai Huang, Foshan (CN); Wenbin Chen, Foshan (CN); Jiawei Chen, Foshan (CN); Yijie Hao, Foshan (CN); Mingyao Li, Foshan (CN)

(21) Appl. No.: 19/026,548

(22) Filed: Jan. 17, 2025

(30) Foreign Application Priority Data
Dec. 20, 2024 (CN) 202411901347.3

(51) Int. Cl. C02F 1/00

(52) U.S. Cl. CPC C02F 1/003; C02F 2209/06; C02F 2209/10

(57) ABSTRACT

A water faucet and water purification equipment with mineralization are provided. The water faucet includes: a body; an obtaining module, arranged at the body and configured to obtain a PH value and/or a Total Dissolved Solids (TDS) value of water; and a display module, arranged at the body and configured to display the PH value and/or the TDS value. A waterway is arranged in the above body. The obtaining module is arranged in the water faucet, and can obtain a PH value and/or a TDS value of water input to the water faucet and obtain a PH value and/or a TDS value of water output from the water faucet. After obtaining the PH values and/or the TDS values of the water input to and output from the water faucet, the obtaining module inputs the values to the display module, the display module displays the PH value and/or the TDS value.

### CROSS REFERENCE TO RELATED APPLICATIONS

The present application claims the benefit of Chinese Patent Application No. 202411901347.3 filed on Dec. 20, 2024, the contents of which are incorporated herein by reference in their entirety.

### TECHNICAL FIELD

The present disclosure relates to the technology field of water faucets, and in particular, to a water faucet and water purification equipment with mineralization.

### BACKGROUND

At present, with the continuous improvement of the living standard, people pay more and more attentions to drinking water. Water that people can drink can roughly include tap water, purified water, and mineral water. The tap water contains impurities, bacteria, and heavy metals. The purified water is acidic and is not beneficial for an acid-base balance of a human body. A water faucet is a terminal device for water. A traditional water faucet used in the current market has a single function, and may not be used to display a Total Dissolved Solids (TDS) value or a PH value of current water.

### SUMMARY

In view of this, the present disclosure provides a water faucet and water purification equipment with mineralization. The water faucet can obtain and display a TDS value and/or a PH value in a body.

The present disclosure provides the following technical solutions:

A water faucet includes:
a body;
an obtaining module, wherein the obtaining module is arranged at the body, and the obtaining module is configured to obtain a PH value and/or a TDS value of water; and
a display module, wherein the display module is arranged at the body; and the display module is configured to display the PH value and/or the TDS value obtained by the obtaining module.

Further, the obtaining module includes a communication unit and a detection unit;
the detection unit is connected to the communication unit; and the detection unit is configured to: obtain the PH value of the water and send the PH value to the display module through the communication unit.

Further, the detection unit is arranged outside the body; and the detection unit is configured to obtain the PH value and/or the TDS value of the water entering the water faucet.

Further, the detection unit is arranged inside the body; and the detection unit is configured to obtain the PH value and/or the TDS value of the water in the water faucet.

Further, the water faucet further includes a controller,
wherein the controller is connected to the obtaining module and the display module respectively; and the controller is configured to: obtain a signal of the obtaining module and output the signal to the display module.

Further, the display module includes but is not limited to: a signal display area, a numerical value display area, a control area, and a PH/TDS display area.

Further, the body includes a main body portion and a connecting portion;
the main body portion is rotationally connected to the connecting portion; the connecting portion is provided with an accommodating chamber; and the communication unit, the detection unit, and the controller are all arranged in the accommodating chamber.

Further, the main body portion is provided with a mounting area, and the display module is arranged in the mounting area.

Further, at least one mineralization waterway is arranged in the body.

Further, a water faucet filter element is arranged at the mineralization waterway, and the water faucet filter element is configured to mineralize water in the mineralization waterway.

Further, the obtaining module is arranged at a water outlet of the mineralization waterway, or a water inlet of the mineralization waterway, or both the water inlet of the mineralization waterway and the water outlet of the mineralization waterway 50.

Further, the body includes an adjustment waterway and a control valve, the control valve is connected to the mineralization waterway and the adjustment waterway, the control valve is configured to control a water inlet volume of the mineralization waterway and a water inlet volume of the adjustment waterway.

The present disclosure further provides water purification equipment with mineralization. The water purification equipment with mineralization includes:
a water purifier and the water faucet. The water faucet is connected to the water purifier.

Further, the obtaining module includes a communication unit and a detection unit; and
the detection unit is connected to the communication unit; and the detection unit is configured to obtain the PH value of the water and send the PH value to the display module through the communication unit.

Further, the detection unit is arranged outside the body; the detection unit is configured to obtain the PH value and/or the TDS value of the water entering the water faucet; the detection unit is arranged inside the body; and the detection unit is configured to obtain the PH value and/or the TDS value of the water in the water faucet.

Further, the water faucet includes a controller,
wherein the controller is connected to the obtaining module and the display module respectively; and the controller is configured to obtain a signal of the obtaining module and output the signal to the display module.

Further, the display module includes a signal display area, a numerical value display area, a control area, and a PH/TDS display area.

Further, the body includes a main body portion and a connecting portion;
the main body portion is rotationally connected to the connecting portion; the connecting portion is provided with an accommodating chamber; and the communication unit, the detection unit, and the controller are all arranged in the accommodating chamber.

Further, the main body portion is provided with a mounting area, and the display module is arranged in the mounting area.

Further, the water purification equipment with mineralization includes a mineralization filter element and a water purification filter element,
wherein the water purification filter element is connected in series to the mineralization filter element; a mineralization waterway is arranged in the water faucet; and the mineralization filter element is configured to supply water to the mineralization waterway.

A waterway is arranged in the above body. Furthermore, the obtaining module is arranged in the water faucet. The obtaining module is arranged at the waterway in the water faucet and can obtain a PH value and/or a TDS value of water input to the water faucet and obtain a PH value and/or a TDS value of water output by the water faucet. In addition, after obtaining the PH values and/or the TDS values of the water input to and output by the water faucet, the obtaining module inputs the values to the display module. After processing a signal input by the obtaining module, the display module displays the PH value and/or the TDS value of the water currently input to the water faucet or the PH value and/or the TDS value of the water currently output by the water faucet.

### BRIEF DESCRIPTION OF THE DRAWINGS

To describe the technical solutions in the embodiments of the present disclosure more clearly, the following briefly describes the accompanying drawings required for describing the implementations. Apparently, the accompanying drawings in the following description show some implementations of the present disclosure, and a person of ordinary skill in the art may still derive other drawings from these accompanying drawings without creative efforts.

FIG. 1 is a schematic structural diagram I of a water faucet according to an embodiment of the present disclosure;

FIG. 2 is a schematic structural diagram II of a water faucet according to an embodiment of the present disclosure;

FIG. 3 is a schematic structural diagram III of a water faucet according to an embodiment of the present disclosure;

FIG. 4 is a schematic structural diagram I of a display module according to an embodiment of the present disclosure;

FIG. 5 is a schematic structural diagram II of a display module according to an embodiment of the present disclosure;

FIG. 6 is a schematic structural diagram III of a display module according to an embodiment of the present disclosure;

FIG. 7 is a schematic diagram I of an entire structure of a water faucet according to an embodiment of the present disclosure;

FIG. 8 is an exploded view of a water faucet according to an embodiment of the present disclosure;

FIG. 9 is cross-sectional view of a water faucet according to an embodiment of the present disclosure; and

FIG. 10 is a schematic structural diagram of water purification equipment with mineralization according to an embodiment of the present disclosure.

### DESCRIPTIONS OF REFERENCE NUMERALS

100: water faucet; 10: body; 11: main body portion; 111: mounting area; 12: connecting portion; 121: accommodating chamber; 20: obtaining module; 21: communication unit; 22: detection unit; 30: display module; 31: signal display area; 32: numerical value display area; 33: PH/TDS display area; 34: control area; 40: controller; 50: mineralization waterway; 60: adjustment waterway; 70: control valve; 80: water faucet filter element; 200: water purification equipment with mineralization; 210: water purifier; 220: mineralization filter element; and 230: water purification filter element.

### DETAILED DESCRIPTION OF THE EMBODIMENTS

The technical solutions in the embodiments of the present disclosure will be clearly and completely described below with reference to the drawings in the embodiments of the present disclosure, and it is obvious that the described embodiments are only a part of the embodiments of the present disclosure but not all of them. All other embodiments obtained by a person of ordinary skill in the art based on the embodiments of present disclosure without making creative efforts shall fall within the protection scope of present disclosure.

This specification and claims of the present disclosure, and terms “first” and “second” in the above accompanying drawings are configured to distinguish different objects, but are unnecessarily configured to describe a specific sequence. In addition, the term “include”, “has”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

Reference to “an embodiment” or “implementation” herein means that a particular feature, structure or characteristic described in conjunction with an embodiment or an implementation may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

At present, with the continuous improvement of the living standard, people pay more and more attentions to drinking water. Water that people can drink can roughly include tap water, purified water, and mineral water. The tap water contains impurities, bacteria, and heavy metals. The purified water is acidic and is not beneficial for an acid-base balance of a human body. A water faucet is a terminal device for water. A traditional water faucet used in the current market has a single function, and may not be used to display a TDS value or a PH value of current water.

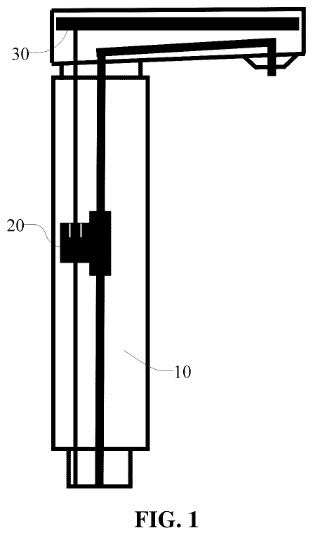

Referring to FIG. 1, a water faucet 100 includes:
a body 10;
an obtaining module 20, wherein the obtaining module 20 is arranged at the body 10, and the obtaining module 20 is configured to obtain a PH value and/or a TDS value of water; and
a display module 30, wherein the display module 30 is arranged at the body 10; and the display module 30 is configured to display the PH value and/or the TDS value obtained by the obtaining module 20.

A waterway is arranged in the above body 10. Furthermore, the obtaining module 20 is arranged in the water faucet 100. The obtaining module 20 is arranged at the waterway in the water faucet 100 and can obtain a PH value and/or a TDS value of water input to the water faucet 100 and obtain a PH value and/or a TDS value of water output by the water faucet 100. In addition, after obtaining the PH values and/or the TDS values of the water input to and output by the water faucet 100, the obtaining module 20 inputs the values to the display module 30. After processing a signal input by the obtaining module 20, the display module 30 can display the PH value and/or the TDS value of the water currently input to the water faucet 100 or the PH value and/or the TDS value of the water currently output by the water faucet 100.

It can be understood that in some implementations, at least one mineralization waterway 50 is arranged in the body 10. Furthermore, the obtaining module 20 is arranged at the mineralization waterway 50. The obtaining module 20 can be arranged at a water outlet of the mineralization waterway 50, or a water inlet of the mineralization waterway 50, or both the water inlet of the mineralization waterway 50 and the water outlet of the mineralization waterway 50. The detection unit is arranged at a desired position to detect a PH value and/or a TDS value of water. The detected PH value and/or the TDS value is sent to the display module 30. The display module 30 can display the currently obtained PH value and/or TDS value to achieve visualization of water quality of the current water. Certainly, the obtaining module 20 in the present disclosure can be configured to obtain the PH value and/or the TDS value of the current water flow and can further obtain other parameters of the current water flow and send detected data to the display module 30 for displaying.

It should be particularly noted that the TDS value in the present disclosure represents the conductivity performance of water.

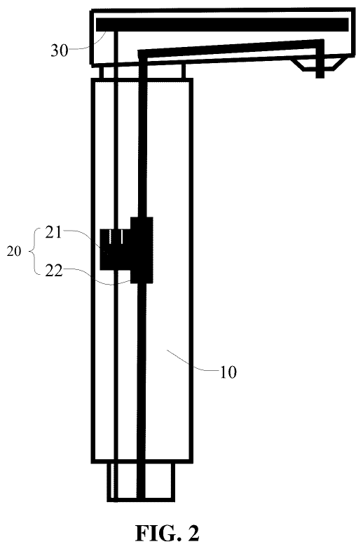

Referring to FIG. 1 and FIG. 2, in some implementations, the obtaining module 20 includes a communication unit 21 and a detection unit 22;
the detection unit 22 is connected to the communication unit 21; and the detection unit 22 is configured to obtain the PH value of the water and send the PH value to the display module 30 through the communication unit 21.

It can be understood that the above obtaining module 20 includes the communication unit 21 and the detection unit 22. The above detection unit 22 is electrically connected to the communication unit 21. The above detection unit 22 is configured to obtain relevant data of current water, for example, to obtain relevant data such as a PH value and/or a TDS value and/or a heavy metal content and/or a microorganism content of the current water. After obtaining the relevant data, the detection unit 22 can communicate with the display module 30 through the communication unit 21. The display module 30 has a communication function and can wirelessly communicate with the communication unit 21. In this way, the data can be sent to the display module 30 through the communication module, and the display module 30 displays the relevant data after processing the relevant data.

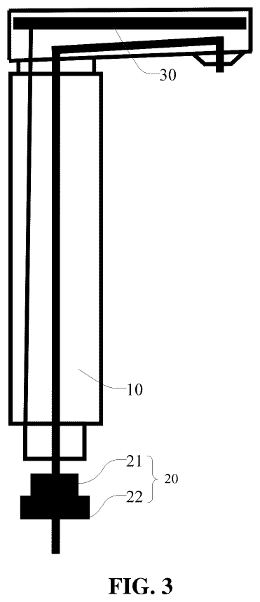

Referring to FIG. 1 and FIG. 3, in some implementations, the detection unit 22 is arranged outside the body 10; and the detection unit 22 is configured to obtain the PH value and/or the TDS value of the water entering the water faucet 100.

It can be understood that the body 10 has a water supply waterway. The water supply waterway may supply municipal water or may be an output waterway of a water purifier. The above detection unit 22 is arranged outside the body 10, namely, at the water supply waterway of the body 10. A PH value and/or a TDS value on the water supply waterway is obtained through the detection unit 22, to detect quality of water currently entering the water faucet 100. After the detection unit 22 has detected the water quality of the inlet water of the current water faucet 100, the water quality is sent to the display module 30 through the communication unit 21 and is displayed through the display module 30.

It can be understood that when the water supply waterway is supplied by the water purifier 210, after a current PH value and/or TDS value of the water supply waterway is detected and displayed, a user can intuitively see the water quality of water that can be output by the current water faucet 100. When the user has a need for drinking water, the user can determine, according to a PH value and/or a TDS value of water input to the water faucet 100, whether the current water can meet the standard of drinking water. If PH values and/or TDS values of water output for long time are large, it can reflect that the current water purifier 210 works abnormally, and a filter element may possibly need to be replaced.

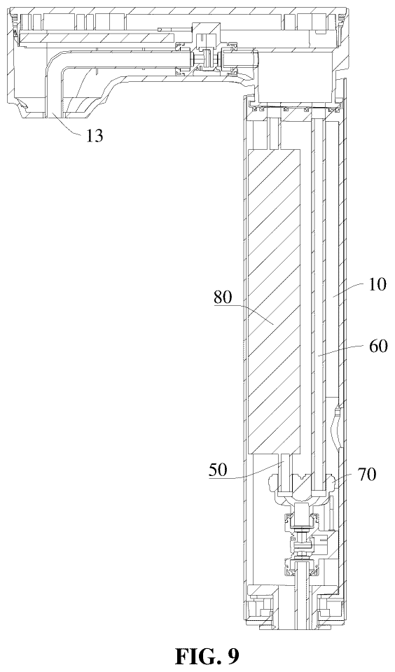

Referring to FIG. 9, in some implementations, a water faucet filter element 80 is arranged in the body 10. The water faucet filter element 80 is arranged at the mineralization waterway 50, and the water faucet filter element 80 is configured to mineralize water in the mineralization waterway 50.

The water faucet filter element 80 is arranged in the body 10, and the water faucet filter element 80 is arranged at the mineralization waterway 50. A filter material for mineralizing water is arranged in the water faucet filter element 80. After water flows through the filter material for mineralization, the mineralization waterway 50 can produce mineralized water. Since most filter materials for mineralization are alkaline materials, after water is mineralized, the water produced in the mineralization waterway 50 has a large PH value. Ideal drinking water should be weakly alkaline. The PH value of the mineralized water in the mineralization waterway 50 exceeds a PH value of the ideal drinking water, so that the PH value of the drinking water produced by the mineralization waterway 50 needs to be adjusted.

Referring to FIG. 9, in some implementations, the body 10 further includes an adjustment waterway 60 and a control valve 70.

The control valve 70 is respectively connected to the mineralization waterway 50 and the adjustment waterway 60. The control valve 70 is configured to control a water inlet volume of the mineralization waterway 50 and a water inlet volume of the adjustment waterway 60.

It can be understood that the control valve 70 is connected to the mineralization waterway 50 and the adjustment waterway 60, so the control valve 70 can achieve the purpose of adjusting water flow rates of the mineralization waterway 50 and the adjustment waterway 60 by controlling the water flow rates. The water flow rates of different waterways are adjusted to make water in the mineralization waterway 50 mixed with water in the adjustment waterway 60 before the water is output from the water faucet 100. This can adjust the PH value of the water.

Referring to FIG. 1 and FIG. 2, in some implementations, the detection unit 22 is arranged inside the body 10; and the detection unit 22 is configured to obtain the PH value and/or the TDS value of the water in the water faucet 100.

It can be understood that the above detection unit 22 may be arranged at a water outlet of the water faucet filter element 80. Since a PH value of mineralized water needs to be adjusted, the detection unit 22 is arranged at the mineralization waterway 50 to detect the PH value of the mineralized water. When the PH value of the mineralized water is large, the water inlet volume of the mineralization waterway can be reduced through the control valve 70, and then the water inlet volume of the adjustment waterway 60 is increased. In this way, the PH value of the water output by the water faucet 100 can be reduced. This can adjust the water output by the water faucet 100.

In some implementations, the above detection unit 22 may be arranged at a water outlet of the water faucet 100 to detect a PH value of current outlet water of the body 10. When it is detected that the PH value of the currently output water is small or large, the body 10 can adjust both the water flow rate in the mineralization waterway 50 and the water flow rate in the adjustment waterway 60 through the control valve 70. For example, when the PH value of the output water is large, the water flow rate of the mineralization waterway 50 can be decreased and the water flow rate of the adjustment waterway 60 can be increased, to decrease the PH value. When the PH value of the output water is small, the water flow rate of the mineralization waterway 50 can be increased and the water flow rate of the adjustment waterway 60 can be decrease, to increase the PH value.

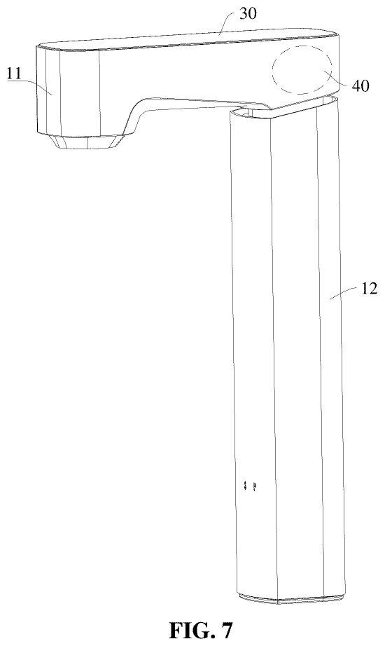

Referring to FIG. 7, in some implementations, the water faucet further includes a controller 40,
wherein the controller 40 is connected to the obtaining module 20 and the display module 30 respectively; and the controller 40 is configured to obtain a signal of the obtaining module 20 and output the signal to the display module 30.

It can be understood that the above controller 40 is arranged outside the water faucet 100 or inside the water faucet 100. The controller 40 is respectively connected to the obtaining module 20 and the display module 30. In this way, the controller 40 can obtain a PH value or a TDS value in a current waterway through the obtaining module 20. After the obtaining module 20 obtains the PH value or the TDS value in the current waterway, the data is sent to the controller 40. The controller 40 can process the obtained relevant data and send the data to the display module 30 for displaying. This can achieve visualization of the water quality of the current waterway.

In some implementations, the controller 40 can further control a water inlet volume of the control valve 70 according to the PH value or the TDS value obtained by the obtaining module 20. For example, when the PH value of the output water is large, the water flow rate of the mineralization waterway 50 can be decreased and the water flow rate of the adjustment waterway 60 can be increased, to decrease the PH value. When the PH value of the output water is small, the water flow rate of the mineralization waterway 50 can be increased and the water flow rate of the adjustment waterway 60 can be decrease, to increase the PH value.

In some implementations, a user can further set a PH value for output water according to a water utilization requirement. After the user sets a water outlet requirement, the controller 40 can output water according to the PH value or the TDS value set by the user. When the obtaining module 20 detects that the PH value or the TDS value of current outlet water exceeds or is less than the value set by the user, the controller 40 can change a ratio of the water inlet volume of the adjustment waterway 60 to the water inlet volume of the mineralization waterway 50 by controlling an opening degree of the control valve 70. In this way, the PH value of the current outlet water of the water faucet 100 can be adjusted, so that the PH value or the TDS value of the current outlet water of the water faucet 100 can be matched with the value preset by the user, to meet the water utilization requirement of the user.

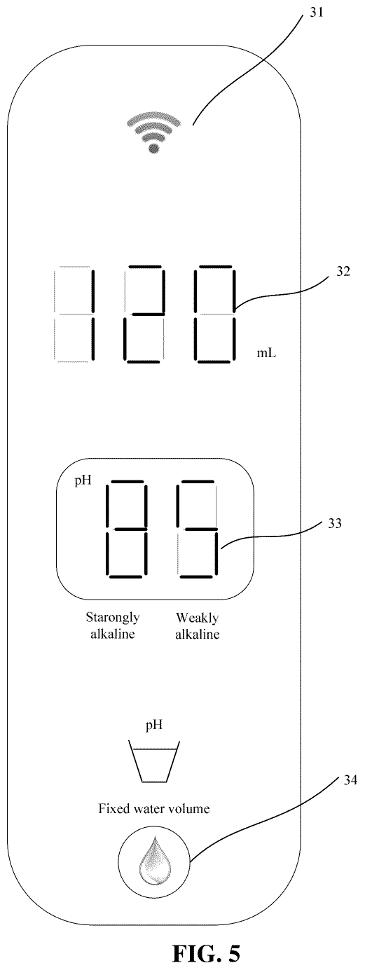

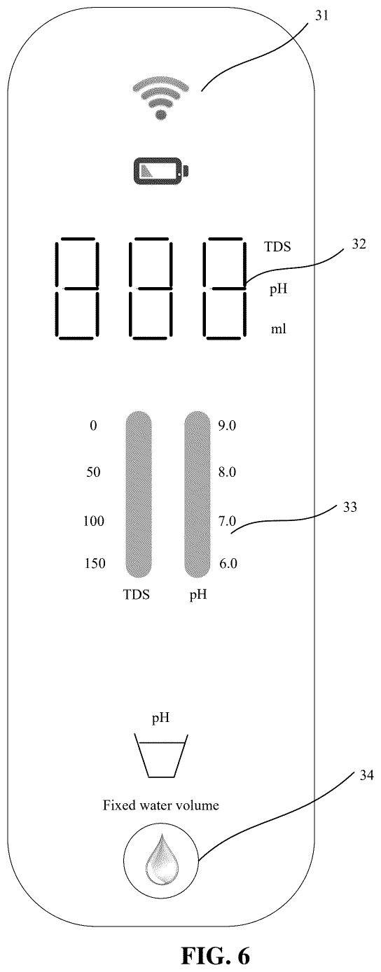

Referring to FIG. 1 and FIG. 4 to FIG. 6, in some implementations, the display module 30 includes but is not limited to: a signal display area 31, a numerical value display area 32, a control area 34, and a PH/TDS display area 33.

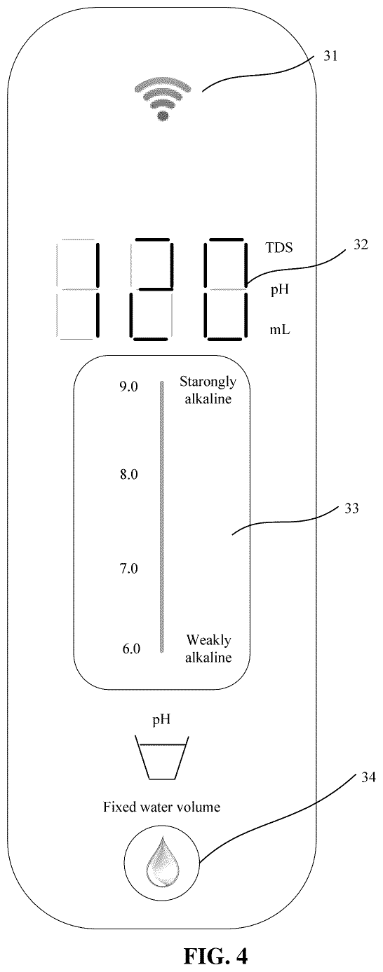

It can be understood that to facilitate observation and control by the display module 30, the display module 30 is divided into a plurality of display areas. Specifically, the display module 30 is divided into the signal display area 31, the numerical value display area 32, the control area 34, and the PH/TDS display area 33. The above signal display area 31 is configured to display a current communication state of the main body 10. The numerical value display area is configured to display a specific value of the current PH/TDS display area 33. The control area 34 can be provided with buttons for setting a PH value of outlet water or a water outlet volume or for pausing water outputting. The PH/TDS display area 33 is configured to display PH/TDS of current water in a bar chart (shown in FIG. 4 to FIG. 6).

Different control modes may be set in the control area 34, and corresponding touch buttons may be arranged in the control area 34. A TDS value or a PH value of water output from the water faucet 100 is adjusted through the touch button. For example, if one control area is set to a fixed TDS value or PH value, the touch button may correspondingly set PH=7, PH=7.5, and PH=8. If another control area is configured to adjust the PH value of the water output from the water faucet 100 by plus or minus, the control area can be set to have a plus or minus sign, and the buttons in different control areas can adjust current values. For example, if a user requires drinking water with a PH value of 7.3, the user can adjust the water through the button PH=7.5 and the minus sign button. This can improve the portability of button adjustment and make it more convenient to preset a PH value for the water faucet 100.

Of course, in some other implementations, only a display area can be set. Or, other setting modes are used.

Referring to FIG. 7, in some implementations, the body 10 includes a main body portion 11 and a connecting portion 12;
the main body portion 11 is rotationally connected to the connecting portion 12; the connecting portion 12 is provided with an accommodating chamber 121; and the communication unit 21, the detection unit 22, and the controller 40 are all arranged in the accommodating chamber 121.

It can be understood that the body 10 includes the connecting portion 12 and the main body portion 11. The main body portion 11 is rotationally arranged on the connecting portion 12, and the main body portion 11 is perpendicular to the connecting portion 12. The structural design that the main body portion 11 is perpendicular to the connecting portion 12 helps to improve the stability of the device, to reduce structural displacement or tilting, improve the stability of the water faucet 100, and further reduce the flowing resistance, thereby improving the water flowing efficiency. Furthermore, it can also facilitate the turning of the water faucet 100.

It can be understood that the above connecting portion 12 is provided with an accommodating chamber 121. The communication unit 21, the detection unit 22, and the controller 40 are arranged in the accommodating chamber 121. The communication unit 21 can be electrically connected to the detection unit 22, and the controller 40 may be wirelessly connected to the communication unit 21. Data is sent to the controller 40 through the communication unit 21 via a wireless signal. Signal transmission can be performed using BLUETOOTH, WI-FI, and other relevant protocols or modules.

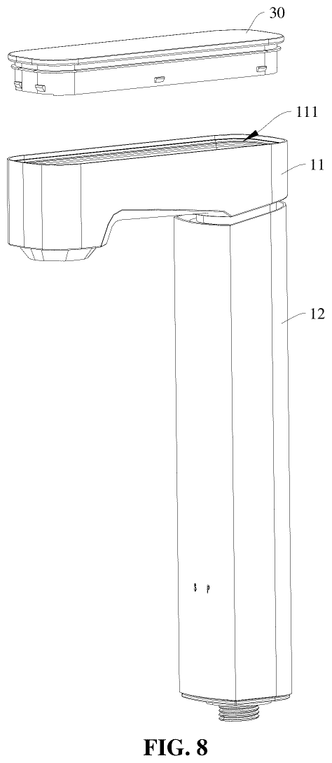

Referring to FIG. 8, in some implementations, the main body portion 11 is provided with a mounting area 111, and the display module 30 is arranged in the mounting area 111.

It can be understood that the main body portion 11 is a water outlet portion of the water faucet, and is rotationally arranged at the connecting portion 12. Furthermore, the mounting area 111 is arranged on one side of the main body portion 11 away from the connecting portion 12. The mounting area 111 is recessed in the main body portion 11. The mounting area 111 is configured to mount the display module 30. On the one hand, the mounting area 111 is configured for facilitating mounting of the display module 30, and on the other hand, the mounting area 111 is configured for facilitating a user to observe and adjust relevant parameters after the display module 30 is mounted in the mounting area 111.

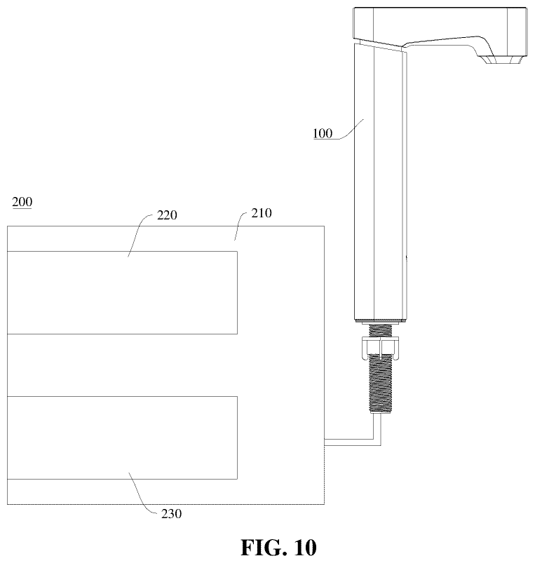

Referring to FIG. 10, the present disclosure further provides water purification equipment with mineralization 200. The water purification equipment with mineralization includes:
a water purifier 210 and the water faucet 100. The water faucet 100 is connected to the water purifier 210.

It can be understood that the above water purification equipment with mineralization 200 includes the water purifier 210 and the water faucet 100. The water purifier 210 is configured to purify municipal water, and purified water enters the water faucet 100. The water faucet 100 can achieve the purpose of adjusting a water flow rate of the mineralization waterway 50 and a water flow rate of the adjustment waterway 60 through the control valve 70 in the water faucet 100. By adjusting the water flow rates of different waterways, water in the mineralization waterway 50 and water in the adjustment waterway 60 can be mixed before the water is output from the water faucet 100, to output water for different needs.

Referring to FIG. 10, in some implementations, the water purification equipment with mineralization 200 includes a mineralization filter element 220 and a water purification filter element 230,
wherein the water purification filter element 230 is connected in series to the mineralization filter element 220; a mineralization waterway 50 is arranged in the water faucet 100; and the mineralization filter element 220 is configured to supply water to the mineralization waterway 50.

It can be understood that the above water purifier 210 includes the mineralization filter element 220 and the water purification filter element 230. The water purification filter element 230 is connected to the mineralization filter element 220. After being purified by the water purification filter element, water flows out and enters the mineralization filter element 220. The mineralization filter element 220 preliminarily mineralizes the water and outputs it to the water faucet 100.

Reference to “an embodiment” or “implementation” in the present disclosure means that a particular feature, structure or characteristic described in conjunction with an embodiment may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described in the present disclosure may be combined with other embodiments. In addition, it should be further understood that provided that there is no contradiction between the features, structures or characteristics described in the various embodiments of the present disclosure, the features, structures, or characteristics can be arbitrarily combined to form another embodiment that does not depart from the spirit and scope of the technical solutions of the present disclosure.

Finally, it should be noted that the above implementations are only configured to explain the technical solutions of the present disclosure and not intended to limit the technical solutions. Although the present disclosure has been described in detail with reference to the preferred implementations, those of ordinary skill in the art should understand that the technical solutions of the present disclosure can be modified or equivalently replaced without departing from the spirit and scope of the technical solutions of the present disclosure.

What is claimed is:

1. A water faucet, comprising:
a body;
an obtaining module, wherein the obtaining module is arranged at the body, and the obtaining module is configured to obtain a PH value and/or a Total Dissolved Solids (TDS) value of water; and
a display module, wherein the display module is arranged at the body; and the display module is configured to display the PH value and/or the TDS value obtained by the obtaining module.

2. The water faucet according to claim 1, wherein the obtaining module comprises a communication unit and a detection unit; and
the detection unit is connected to the communication unit; and the detection unit is configured to obtain the PH value of the water and send the PH value to the display module through the communication unit.

3. The water faucet according to claim 2, wherein the detection unit is arranged outside the body; and the detection unit is configured to obtain the PH value and/or the TDS value of the water entering the water faucet.

4. The water faucet according to claim 2, wherein the detection unit is arranged inside the body; and the detection unit is configured to obtain the PH value and/or the TDS value of the water in the water faucet.

5. The water faucet according to claim 2, further comprising a controller,
wherein the controller is connected to the obtaining module and the display module respectively; and the controller is configured to obtain a signal of the obtaining module and output the signal to the display module.

6. The water faucet according to claim 5, wherein the display module comprises a signal display area, a numerical value display area, a control area, and a PH/TDS display area.

7. The water faucet according to claim 6, wherein the body comprises a main body portion and a connecting portion;
the main body portion is rotationally connected to the connecting portion; the connecting portion is provided with an accommodating chamber; and the communication unit, the detection unit, and the controller are all arranged in the accommodating chamber.

8. The water faucet according to claim 7, wherein the main body portion is provided with a mounting area, and the display module is arranged in the mounting area.

9. The water faucet according to claim 7, wherein at least one mineralization waterway is arranged in the body.

10. The water faucet according to claim 9, wherein a water faucet filter element is arranged at the mineralization waterway, and the water faucet filter element is configured to mineralize water in the mineralization waterway.

11. The water faucet according to claim 10, wherein the obtaining module is arranged at a water outlet of the mineralization waterway, or a water inlet of the mineralization waterway, or both the water inlet of the mineralization waterway and the water outlet of the mineralization waterway 50.

12. The water faucet according to claim 11, wherein the body further comprises an adjustment waterway and a control valve, the control valve is connected to the mineralization waterway and the adjustment waterway, the control valve is configured to control a water inlet volume of the mineralization waterway and a water inlet volume of the adjustment waterway.

13. Water purification equipment with mineralization, wherein the water purification equipment with mineralization comprises:
a water purifier; and
the water faucet according to claim 1, wherein the water faucet is connected to the water purifier.

14. The water purification equipment with mineralization according to claim 13, wherein the obtaining module comprises a communication unit and a detection unit; and
the detection unit is connected to the communication unit; and the detection unit is configured to obtain the PH value of the water and send the PH value to the display module through the communication unit.

15. The water purification equipment with mineralization according to claim 14, wherein the detection unit is arranged outside the body; the detection unit is configured to obtain the PH value and/or the TDS value of the water entering the water faucet; or
the detection unit is arranged inside the body; and the detection unit is configured to obtain the PH value and/or the TDS value of the water in the water faucet.

16. The water purification equipment with mineralization according to claim 14, wherein the water faucet further comprises a controller,
wherein the controller is connected to the obtaining module and the display module respectively; and the controller is configured to obtain a signal of the obtaining module and output the signal to the display module.

17. The water purification equipment with mineralization according to claim 16, wherein the display module comprises a signal display area, a numerical value display area, a control area, and a PH/TDS display area.

18. The water purification equipment with mineralization according to claim 17, wherein the body comprises a main body portion and a connecting portion;
the main body portion is rotationally connected to the connecting portion; the connecting portion is provided with an accommodating chamber; and the communication unit, the detection unit, and the controller are all arranged in the accommodating chamber.

19. The water purification equipment with mineralization according to claim 18, wherein the main body portion is provided with a mounting area, and the display module is arranged in the mounting area.

20. The water purification equipment with mineralization according to claim 13, comprising a mineralization filter element and a water purification filter element,
wherein the water purification filter element is connected in series to the mineralization filter element; a mineralization waterway is arranged in the water faucet; and the mineralization filter element is configured to supply water to the mineralization waterway.
